(19) United States
(12) Patent Application Publication
(10) Pub. No.: US 2026/0160602 A1
(43) Pub. Date: Jun. 11, 2026

(54) SEMICONDUCTOR DEVICE, METHOD FOR CONTROLLING THE SEMICONDUCTOR DEVICE, AND PROGRAM

(71) Applicant: Renesas Electronics Corporation, Tokyo (JP)

(72) Inventors: Keisuke MATSUMOTO, Tokyo (JP); Naoya TOKIMOTO, Tokyo (JP)

(21) Appl. No.: 19/388,595

(22) Filed: Nov. 13, 2025

(30) Foreign Application Priority Data
Dec. 11, 2024 (JP) 2024-216286

(51) Int. Cl. G01K 1/022; G01K 1/024; G08B 21/18

(52) U.S. Cl. CPC G01K 1/022; G01K 1/024; G08B 21/182

(57) ABSTRACT

A semiconductor device, a control method for the semiconductor device, and a program for efficiently storing values in memory are provided. The semiconductor device 100 includes a data acquisition unit 1, a determination unit 2, and memory 3. The data acquisition unit 1 acquires a data signal SIG input from the outside at a predetermined cycle. Determination unit 2 stores a threshold. Determination unit 2 performs a threshold determination by comparing the measurement value M indicated by the data signal SIG acquired by the data acquisition unit 1 with the threshold. If, in the threshold determination, the measurement value M is determined to be an abnormal value that does not meet the predetermined criteria, the measurement value M is stored in memory 3.

### CROSS-REFERENCE TO RELATED APPLICATIONS

The disclosure of Japanese Patent Application No. 2024-216286 filed on Dec. 11, 2024, including the specification, drawings and abstract is incorporated herein by reference in its entirety.

### BACKGROUND

This disclosure relates to a semiconductor device, method for controlling the semiconductor device, and a program. For example, this disclosure can be used in a semiconductor device that stores measurement values in memory in a measuring device, as well as in the control method and program for the semiconductor device.

### BACKGROUND OF THE INVENTION

In measuring devices that measure environmental indicators such as temperature, humidity, and gas concentration, a semiconductor device that acquires measurement values based on signals from sensors is installed. The measuring devices for environmental measurement are expected to be used in confined spaces such as coal mines and tunnels. In such cases, the measuring device is used in harsh environments such as high temperature and humidity, filled with toxic and flammable gases, and where communication with the outside is difficult. Therefore, it is often operated in an unmanned state, such as being fixed at a point or mounted on a work robot, conducting environmental surveys and fixed-point environmental surveys before human work.

When operating a measuring device unmanned in harsh environments, real-time communication between the measuring device and an external management system can be difficult. For example, if the measuring device is installed in a remote and narrow location, the installation of cables is restricted, making wired communication difficult. Moreover, in the case of wired communication, communication with measuring devices installed in multiple locations requires a lot of materials and preparation work. Even when using wireless communication, it is difficult to maintain a good communication state. Therefore, generally, the measurement values obtained through sensors are accumulated in the memory provided in the measuring device. Then, by moving the measuring device or memory to a location where it can communicate with the management system, the measurement values are stored in the management system.

There are disclosed techniques listed below.

[Patent Document 1] Japanese Unexamined Patent Application Publication No. 2002-81847

For example, in Patent Document 1, a temperature recording device that stores the measured temperature is proposed. The temperature recording device according to Patent Document 1 stores the alarm period when the detected temperature is outside the set temperature range as temperature alarm history data.

### SUMMARY

However, in a measuring device installed without communication with the outside, the number of measurement values that can be stored in memory is limited by the memory capacity. However, since the size of the measuring device is constrained, increasing the memory capacity is also constrained. Therefore, it is difficult to increase the number of measurement values stored in the memory provided in the measuring device.

Other objects and novel features will become apparent from the description of this specification and the accompanying drawings.

According to one embodiment, the semiconductor device comprises a memory, a data acquisition unit that acquires data signals input from the outside at a predetermined cycle, and a determination unit in which a threshold is stored. The determination unit performs a threshold determination by comparing the data value indicated by the data signal acquired by the data acquisition unit with the threshold, and if it is determined in the threshold determination that the data value is an abnormal value that does not meet a predetermined determination criterion, the data value is stored in the memory.

According to one embodiment, method for controlling a semiconductor device comprises acquiring data signals input from the outside at a predetermined cycle, performing a threshold determination by comparing the data value indicated by the acquired data signal with the threshold, and storing the data value in the memory provided in the semiconductor device if it is determined in the threshold determination that the data value is an abnormal value that does not meet a predetermined determination criterion.

According to one embodiment, a program to run on a computer comprises processing to acquire data signals input from the outside at a predetermined cycle, processing to perform a threshold determination by comparing the data value indicated by the acquired data signal with the threshold, and processing to store the data value in the memory provided in the semiconductor device if it is determined in the threshold determination that the data value is an abnormal value that does not meet a predetermined determination criterion.

According to one embodiment, a semiconductor device, a method for controlling the semiconductor device, and a program that efficiently stores values in memory provided in the semiconductor device can be provided.

### BRIEF DESCRIPTION OF THE DRAWINGS

FIG. 1 is a block diagram schematically showing the configuration of a semiconductor device according to the first embodiment.

FIG. 2 is a block diagram showing the configuration of peripheral devices of the semiconductor device according to the first embodiment.

FIG. 3 is a block diagram schematically showing a configuration example of the semiconductor device according to the first embodiment.

FIG. 4 is a flowchart showing the operation of the semiconductor device according to the first embodiment.

FIG. 5 is a diagram showing an example of storing measurement values in memory in the semiconductor device according to the first embodiment.

FIG. 6 is a block diagram schematically showing the configuration of a semiconductor device according to the second embodiment.

FIG. 7 is a flowchart showing the operation of the semiconductor device according to the second embodiment.

FIG. 8 is a diagram showing an example of storing measurement values in memory in the semiconductor device according to the second embodiment.

FIG. 9 is a block diagram schematically showing the configuration of a semiconductor device according to the third embodiment.

FIG. 10 is a flowchart showing the operation of the semiconductor device according to the third embodiment.

FIG. 11 is a diagram showing an example of storing measurement values in memory in the semiconductor device according to the third embodiment.

FIG. 12 is a diagram showing a configuration example of a computer for realizing the semiconductor device.

### DETAILED DESCRIPTION

Preferred embodiments of the present invention will be described with reference to the accompanying drawings. In each drawing, the same elements are denoted by the same reference numerals, and repetitive descriptions are omitted as necessary.

### First Embodiment

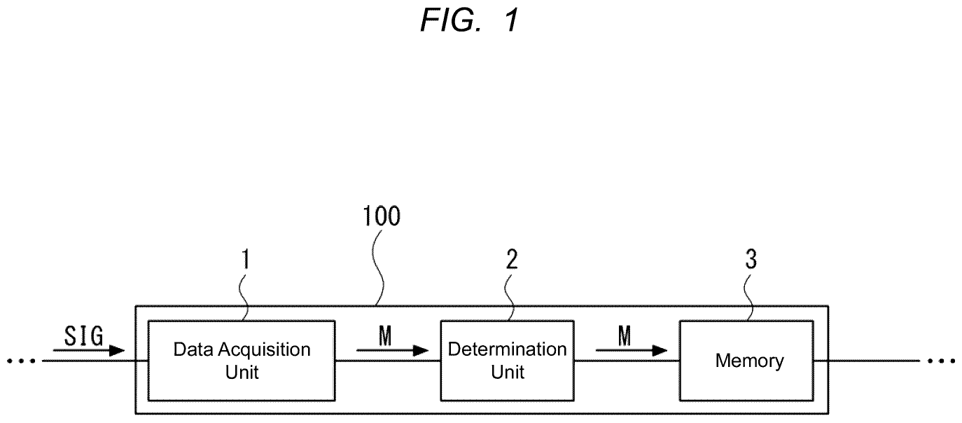

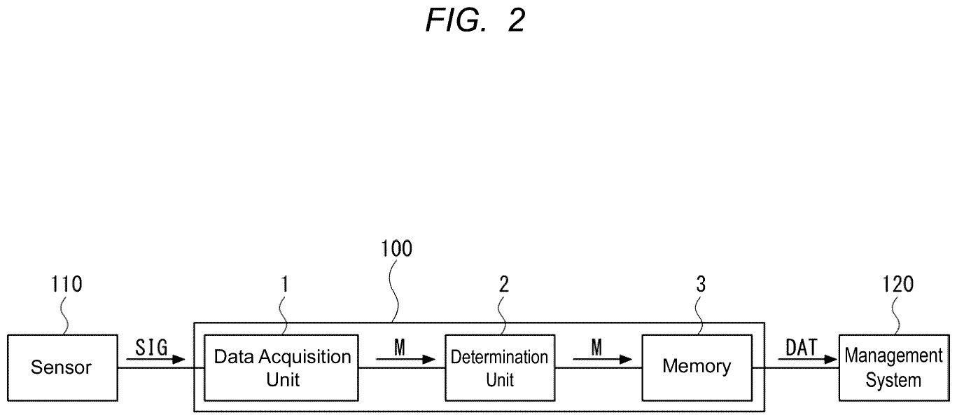

In this embodiment, a semiconductor device is described that stores desired data values, selected based on predetermined criteria, in memory from among the data values obtained based on data signals input from external sources. FIG. 1 is a block diagram schematically showing the configuration of a semiconductor device according to the first embodiment. FIG. 2 is a block diagram showing the configuration of peripherals of the semiconductor device according to the first embodiment. The semiconductor device 100 stores the measurement value M, which is the data value indicated by the data signal SIG, in the memory provided in the semiconductor device 100 when the value indicated by the data signal SIG input from the sensor 110 does not meet predetermined criteria. Semiconductor device 100 includes a data acquisition unit 1, a determination unit 2, and a memory 3.

In this embodiment, an example where the sensor 110 is a temperature sensor is described. The sensor 110 may be installed at any location. The sensor 110 measures the temperature T of the installation location. The sensor 110 outputs the data signal SIG, which is an analog signal indicating the measured temperature T, to the data acquisition unit 1 of the semiconductor device 100.

The data acquisition unit 1 samples the received data signal SIG at a predetermined sampling period f1. The data acquisition unit 1 obtains the measurement value M, which is a digital value, by converting the sampled data signal SIG from analog to digital. Hereinafter, analog/digital conversion will be abbreviated as A/D conversion. The data acquisition unit 1 outputs the measurement value M to the determination unit 2.

Note that the sensor 110 may output the data signal SIG, which indicates the measured temperature T, as a digital signal. In this case, the data acquisition unit 1 may convert the received data signal SIG into the measurement value M.

The determination unit 2 performs a threshold determination by comparing the measurement value M with a predetermined threshold to determine whether the measurement value M meets the predetermined criteria. In this embodiment, an example where the determination unit 2 determines whether the measurement value M falls within a reference range between a lower limit value ML and an upper limit value MH will be described. Hereinafter, a measurement value M that falls within the reference range is referred to as a normal value. A measurement value M that does not fall within the reference range is referred to as an abnormal value. The determination unit 2 discards the measurement value M without storing it in memory 3 if the measurement value M is a normal value. If the measurement value M is an abnormal value, determination unit 2 stores the measurement value M in the memory 3. The reference range between the lower limit value ML and the upper limit value MH is also referred to as the first range.

The measurement value M stored in memory 3 is read by the management system 120 by connecting the semiconductor device 100 to the management system 120 through various communication means. The management system 120 stores the data DAT, which includes multiple read measurement values M, in a memory provided in the management system 120, for example.

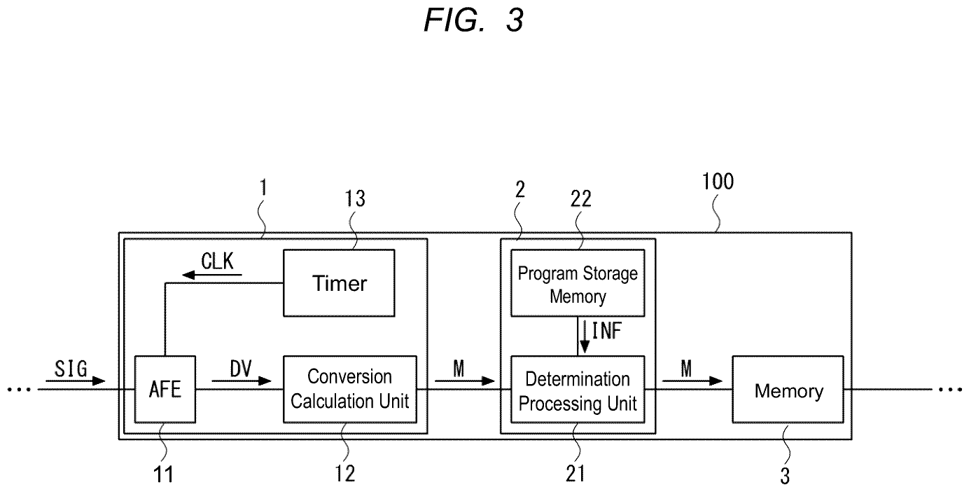

Next, a configuration example of the semiconductor device 100 will be described. FIG. 3 is a block diagram schematically showing a configuration example of the semiconductor device according to the first embodiment. In the example of FIG. 3, the data acquisition unit 1 includes an analog front end (AFE) 11, a conversion calculation unit 12, and a timer 13.

The AFE 11 samples the data signal SIG output by the sensor 110 according to the sampling clock CLK of period f1 output by the timer 13. The AFE 11 performs A/D conversion on the sampled data signal SIG to obtain a digital value DV. The conversion calculation unit 12 converts the digital value DV into the measurement value M. The conversion calculation unit 12 outputs the converted measurement value M to the determination unit 2.

The determination unit 2 includes determination processing unit 21 and a program storage memory 22. The program storage memory 22 stores a determination program that executes the comparison determination process between the measurement value M and the reference range. The determination processing unit 21 reads the determination program from the program storage memory 22 as needed. By executing the determination program, the determination processing unit 21 performs a determination process that compares the measurement value M with the reference range. The determination processing unit 21 may store information indicating the reference range or threshold to be compared with the measurement value M. Determination processing unit 21 may read the reference range and threshold stored in the program storage memory 22 as needed or based on a command from the user of the semiconductor device 100. In FIG. 3, the information such as the determination program, reference range, and threshold read by the determination processing unit 21 from the program storage memory 22 is displayed as information INF.

Next, the operation of the semiconductor device 100 will be described. The semiconductor device 100 continuously samples the data signal SIG according to the sampling clock CLK to obtain multiple temporally discrete measurement values M. The semiconductor device 100 selects the measurement values M to be stored in memory 3 based on the result of the threshold determination comparing the measurement value M with the reference range.

Hereinafter, the determination unit 2 determines that the measurement value M is a normal value if it is equal to or greater than the lower threshold ML and equal to or less than the upper threshold MH. The determination unit 2 determines that the measurement value M is an abnormal value if it is less than the lower threshold ML or greater than the upper threshold MH.

In this embodiment, the semiconductor device 100 stores the measurement value M in memory 3 if it is an abnormal value. If the measurement value M is a normal value, the semiconductor device 100 determines whether to store the measurement value M in memory 3 based on whether the measurement value MPRE from the previous sampling was a normal value or an abnormal value. If the measurement value M from the current sampling is a normal value and the measurement value MPRE from the previous sampling was an abnormal value, the determination unit 2 stores the measurement value M in memory 3. If both the measurement value M from the current sampling and the measurement value MPRE from the previous sampling are normal values, determination unit 2 discards the measurement value M without storing it in memory 3.

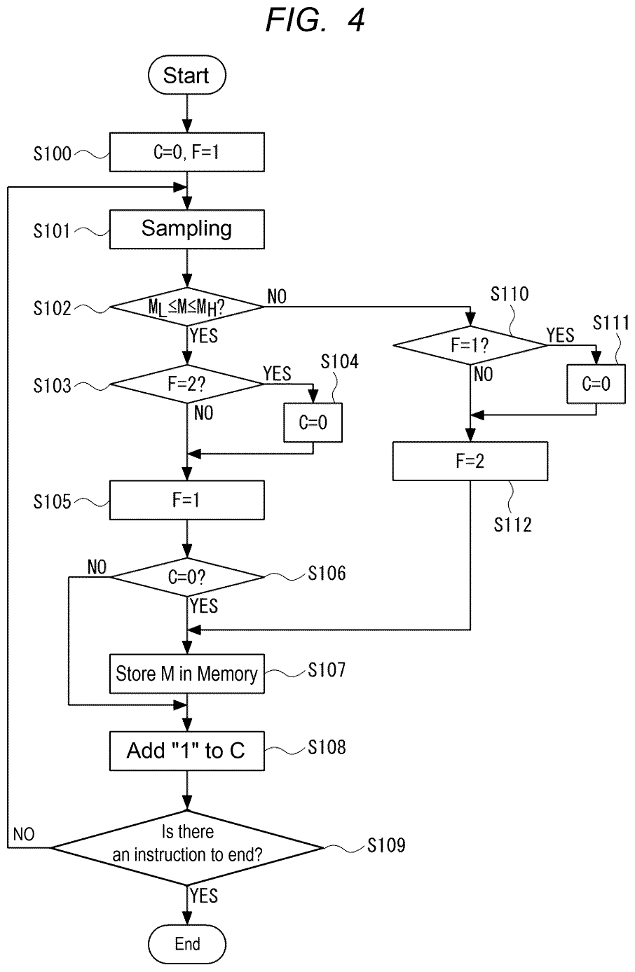

FIG. 4 is a flowchart showing the operation of the semiconductor device according to the first embodiment. In the following, the previous measurement flag F is flag information indicating whether the measurement value MPRE from the previous sampling was a normal value. A value of “1” for the previous measurement flag F indicates that the measurement value MPRE from the previous sampling was a normal value. A value of “2” for the previous measurement flag F indicates that the measurement value MPRE from the previous sampling was an abnormal value. The count value C indicates the number of consecutive measurement values M that are normal or abnormal.

### Step S100

The determination unit 2 sets the initial value of the count value C to “0”. The determination unit 2 sets the initial value of the previous measurement flag F to “1”.

### Step S101

The data acquisition unit 1 samples the data signal SIG output by the sensor 110 at the set sampling period. The data acquisition unit 1 outputs the measurement value M obtained by A/D converting the data signal SIG to the determination unit 2.

### Step S102

The determination unit 2 determines whether the measurement value M is a normal value.

### Step S103

If the measurement value M is a normal value, the determination unit 2 determines whether the value of the previous measurement flag F is “2”. In other words, the determination unit 2 determines whether the measurement value MPRE from the previous sampling was an abnormal value.

### Step S104

If the value of the previous measurement flag F is “2”, that is, if the measurement value MPRE from the previous sampling was an abnormal value, the determination unit 2 sets the count value C to “0”.

### Step S105

If it is determined in step S103 that the value of the previous measurement flag F is not “2”, or after step S104, the determination unit 2 sets the value of the previous measurement flag F to “1”.

### Step S106

The determination unit 2 determines whether the count value C is “0”. If the count value C is “1” or more, the determination unit 2 proceeds to step S108.

### Step S107

If the count value C is “0”, the determination unit 2 stores the measured value M in the memory 3.

### Step S108

The determination unit 2 adds “1” to the count value C.

### Step S109

The determination unit 2 determines whether there is an instruction to end the measurement for the semiconductor device 100. The instruction to end the measurement may be given to the semiconductor device 100 by the user of the semiconductor device 100 as needed. Additionally, a timer may be provided inside or outside the semiconductor device 100, and an instruction to end the measurement may be given from the timer to the semiconductor device 100 when a predetermined time or the accumulated measurement time reaches a predetermined time. If there is an instruction to end the measurement for the semiconductor device 100, the determination unit 2 ends the process. If there are no instructions to end the measurement for semiconductor device 100, determination unit 2 returns the process to step S101.

### Step S110

If the measured value M is determined to be an abnormal value in step S102, determination unit 2 determines whether the previous measurement flag F is “1”, that is, whether the measured value MPRE in the previous sampling was normal value.

### Step S111

If the previous measurement flag F is “1”, the determination unit 2 sets the count value C to “0”.

### Step S112

If it is determined in step S110 that the previous measurement flag F is not “1”, or after step S111, the determination unit 2 sets the value of the previous measurement flag F to “2”. Then, determination unit 2 proceeds the process to step S107.

By repeating the loop process described above with reference to FIG. 4 according to the sampling of the data signal SIG, it is possible to preferentially store measured values indicating abnormal values in the memory.

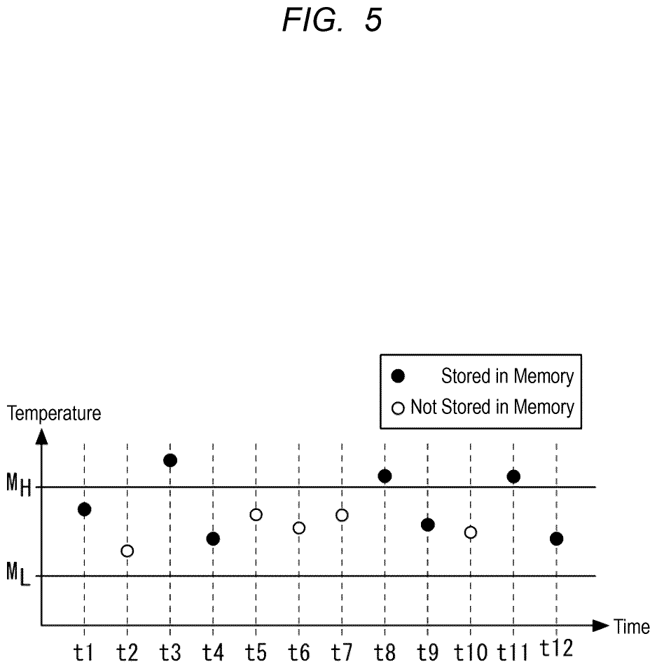

Next, the storage of measured values in the memory of the semiconductor device 100 will be described using an example. FIG. 5 is a diagram showing an example of storing measured values in the memory in the semiconductor device according to the first embodiment. In FIG. 5, 12 measured values sampled at consecutive timings t1 to t12 are shown. The black circles indicate measured values stored in memory 3. The white circles indicate measured values discarded without being stored in memory 3.

In this example, the measured value at the first timing t1 is a normal value. Therefore, the measured value at timing t1 is stored in memory 3.

The measured value at timing t2 is a normal value. Also, the measured value at the previous timing t1 is a normal value. Therefore, the measured value at timing t2 is discarded without being stored in memory 3.

The measured value at timing t3 is an abnormal value. Therefore, the measured value at timing t3 is stored in memory 3.

The measured value at timing t4 is a normal value. On the other hand, the measured value at the previous timing t3 is an abnormal value. Therefore, the measured value at timing t4 is stored in memory 3.

The measured values at timings t5 to t7 are normal values. Also, the measured values at the respective previous timings are normal values. Therefore, the measured values at timings t5 to t7 are discarded without being stored in memory 3.

The measured value at timing t8 is an abnormal value. Therefore, the measured value at timing t8 is stored in memory 3.

The measured value at timing t9 is a normal value. On the other hand, the measured value at the previous timing t8 is an abnormal value. Therefore, the measured value at timing t9 is stored in memory 3.

The measured value at timing t10 is a normal value. Also, the measured value at the previous timing t9 is a normal value. Therefore, the measured value at timing t10 is discarded without being stored in memory 3.

The measured value at timing t11 is an abnormal value. Therefore, the measured value at timing t11 is stored in memory 3.

The measured value at timing t12 is a normal value. On the other hand, the measured value at the previous timing t11 is an abnormal value. Therefore, the measured value at timing t12 is stored in memory 3.

According to semiconductor device 100, only 7 measured values selected from 12 measured values can be stored in memory 3. This reduces the number of values stored in memory 3 compared to storing all measured values in memory 3.

As described above, semiconductor device 100 can reliably store the measured value M in memory 3 when the measured value M is an abnormal value. This allows, for example, the temperature T indicated by the measured value M to be reliably recorded when it is an abnormal value.

Furthermore, when the temperature indicated by the measured value M is continuously a normal value, the semiconductor device 100 stores only the first measured temperature in memory 3. Then, the semiconductor device 100 discards the temperatures measured from the second time onward. This reduces the number of measured values stored in memory 3. Additionally, since the first measured temperature can be recorded, the start of the period during which the temperature is a normal value can be clearly recorded.

Therefore, the semiconductor device 100 can efficiently store the desired measurement values in memory 3. As a result, even if the capacity of memory 3 is limited, it is possible to accumulate measurement values over a long period.

Additionally, according to the semiconductor device 100, the desired measurement values can be efficiently stored in memory 3 through the determination processing in the determination unit 2 without changing the configuration of existing semiconductor devices. Consequently, it is possible to avoid an increase in the configuration and manufacturing cost of the semiconductor device.

Furthermore, since unnecessary measurement values can be avoided from being stored in memory 3, it is possible to reduce the power consumption required for storing measurements. As a result, the power consumption of the semiconductor device can be reduced. When the measuring device equipped with the semiconductor device 100 is configured as a portable device, the reduction in power consumption is particularly advantageous.

### Second Embodiment

In environmental measurement, it is required to detect a state where the measurement values become abnormal values, which may have a significant impact on people and various devices. In this case, it is desirable to monitor the state where the measurement values become abnormal values more precisely than the state where the measurement values are normal. Additionally, in the state where the measurement values become abnormal, it may be necessary to issue an alarm as needed. Therefore, in this embodiment, a semiconductor device that monitors measurement values more frequently when they indicate abnormal values will be described.

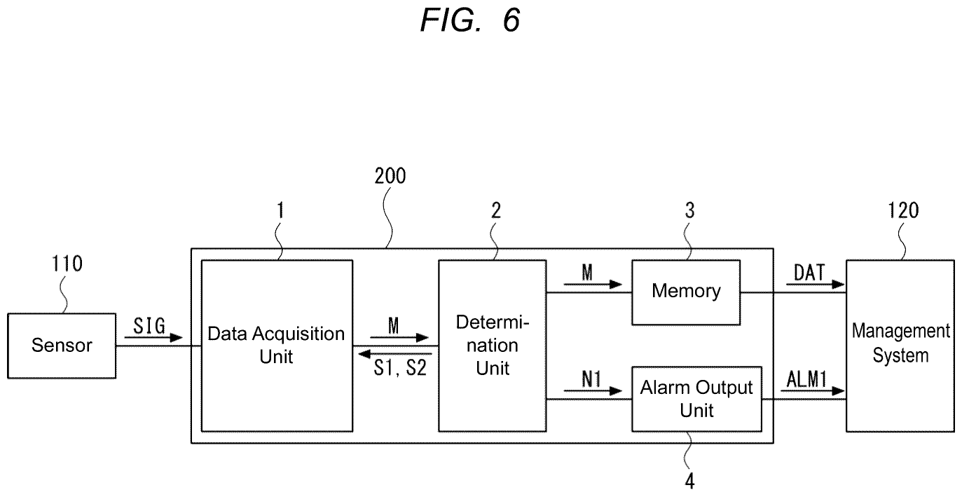

FIG. 6 is a block diagram schematically showing the configuration of a semiconductor device according to the second embodiment. The semiconductor device 200 has a configuration that further includes an alarm output unit 4 compared to the semiconductor device 100. Moreover, The operation of the determination unit 2 in the semiconductor device 200 differs from that of the determination unit 2 in the semiconductor device 100 in that it sets the sampling period of the measurement value according to whether the measurement value is a normal value or an abnormal value.

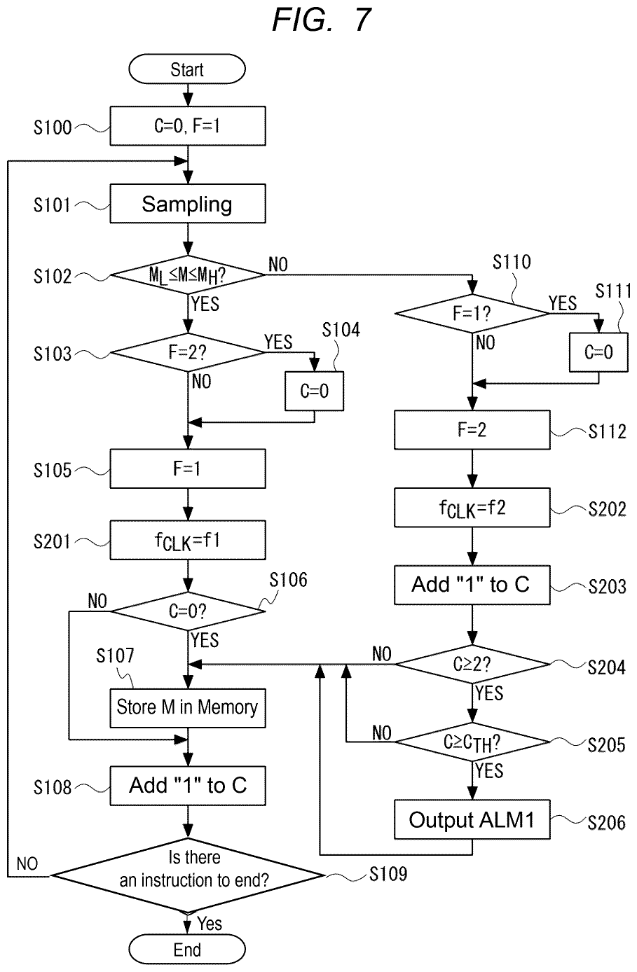

Next, the operation of semiconductor device 200 will be described. FIG. 7 is a flowchart showing the operation of the semiconductor device according to the second embodiment. In FIG. 7, steps S201 to S206 are added compared to FIG. 4.

### Steps S100 to S105

The steps S100 to S105 in FIG. 7 are the same as steps S100 to S105 in FIG. 4, so the overlapping description is omitted.

### Step S201

After step S105, determination unit 2 outputs the sampling period setting notification S1 to the data acquisition unit 1. The data acquisition unit 1 sets the sampling period fCLK to f1 according to the sampling period setting notification S1.

### Steps S106 to S112

Steps S106 to S112 in FIG. 7 are the same as steps 6 to S112 in FIG. 4, so the overlapping description is omitted.

### Step S202

After step S112, determination unit 2 outputs the sampling period setting notification S2 to the data acquisition unit 1. The data acquisition unit 1 sets the sampling period fCLK to a shorter f2 (f2<f1) according to the sampling period setting notification S2.

### Step S203

The determination unit 2 adds “1” to the count value C.

### Step S204

The determination unit 2 determines whether the count value C is “2” or more. If the count value C is “1” or less, the determination unit 2 proceeds to step S107.

### Step S205

If the count value C is “2” or more, the determination unit 2 determines whether the count value C is equal to or greater than the threshold CTH. If the count value C is less than the threshold CTH, the determination unit 2 proceeds to step S107.

### Step S206

If the count value C is equal to or greater than the threshold CTH, the determination unit 2 outputs the alarm notification N1 to the alarm output unit 4. The alarm output unit 4 outputs the alarm ALM1, indicating that the measurement value M has consecutively become abnormal for CTH times or more, to the management system 120, for example. Subsequently, the determination unit 2 proceeds to step S107. The alarm notification N1 is also referred to as the first notification. Alarm ALM1 is also referred to as the first alarm.

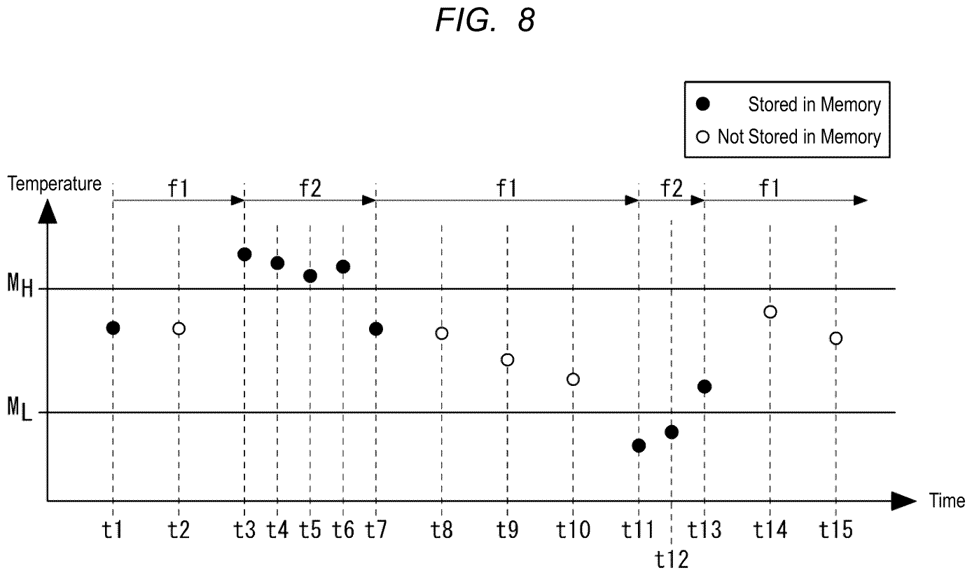

Next, the storage of measurement values in the memory of the semiconductor device 200 will be described using an example. FIG. 8 is a diagram showing an example of storing measurement values in the memory of the semiconductor device according to the second embodiment. In FIGS. 8, 15 measurement values sampled at consecutive timings t1 to t15 are shown. The black circles indicate measurement values stored in memory 3. The white circles indicate measurement values discarded without being stored in memory 3. Here, the threshold CTH in step S205 is set to 3.

In this example, the measurement value at the first timing t1 is a normal value. Therefore, the measurement value at timing t1 is stored in memory 3.

The measurement value at timing t2 is a normal value. Also, the measurement value at the previous timing t1 is a normal value. Therefore, the measurement value at timing t2 is discarded without being stored in memory 3.

The measurement values from timing t3 to t6 are abnormal values. Therefore, the measurement values from timing t3 to t6 are stored in memory 3. Additionally, since the measurement values have consecutively become abnormal three or more times, the alarm output unit 4 outputs the alarm ALM1 at timing t6.

The measurement value at timing t7 is normal value. On the other hand, the measurement value at the previous timing t6 is an abnormal value. Therefore, the measurement value at timing t7 is stored in memory 3.

The measurement values from timing t8 to t10 are normal values. Also, the measurement values at the previous timings are normal values. Therefore, the measurement values from timing t8 to t10 are discarded without being stored in memory 3.

The measurement values at timings t11 and t12 are abnormal values. Therefore, the measurement values at timings t11 and t12 are stored in memory 3.

The measurement value at timing t13 is a normal value. On the other hand, the measurement value at the previous timing t12 is an abnormal value. Therefore, the measurement value at timing t13 is stored in memory 3.

The measurement values at timings t14 and t15 are normal values. Also, the measurement values at the previous timings are normal values. Therefore, the measurement values at timings t14 and t15 are discarded without being stored in memory 3.

Thus, according to semiconductor device 200, only 9 measurement values selected from 15 measurement values can be stored in memory 3. This reduces the number of values stored in memory 3 compared to storing all measured values.

As described above, the semiconductor device 200, like the semiconductor device 100, can efficiently store desired measurement values in memory 3. As a result, even if the capacity of memory 3 is limited, measurement values can be accumulated over a long period.

Moreover, the semiconductor device 200 uses a higher sampling rate when the measurement value M is an abnormal value compared to when it is a normal value. Therefore, it is possible to monitor more closely and measure the state where the measurement value M indicates an abnormal value with high temporal density. As a result, undesirable states where the measurement value becomes abnormal can be monitored more precisely.

Furthermore, the semiconductor device 200 can output an alarm when a predetermined number or more measurement values consecutively become abnormal values. This allows the semiconductor device 200 to notify users of the measuring device on which it is mounted that an undesirable state where the measurement value becomes abnormal is continuing. As a result, the alarm can prevent people from entering areas where entry is undesirable.

### Third Embodiment

In environments where ventilation is restricted, such as inside tunnels, monitoring the concentration of toxic gases is required to prevent health hazards. Toxic gases can immediately lead to health hazards depending on their concentration, so it is necessary to output alarms appropriately according to the concentration of toxic gases. On the other hand, in the second embodiment, a semiconductor device that outputs an alarm when measurement values consecutively become abnormal values a predetermined number of times or more was described. However, when the concentration of toxic gases may immediately lead to health hazards, it is desirable to output an alarm regardless of the number of times abnormal values are observed. Therefore, in the present embodiment, a semiconductor device that outputs an alarm immediately when the measurement value becomes abnormal will be described.

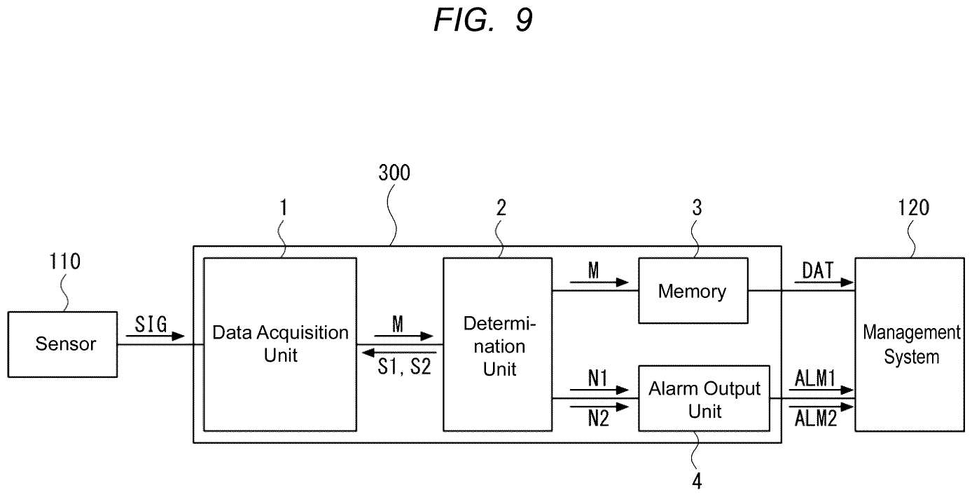

FIG. 9 is a block diagram schematically showing the configuration of the semiconductor device according to the third embodiment. Compared to the semiconductor device 100, the semiconductor device 300 outputs not only alarm ALM1 but also alarm ALM2.

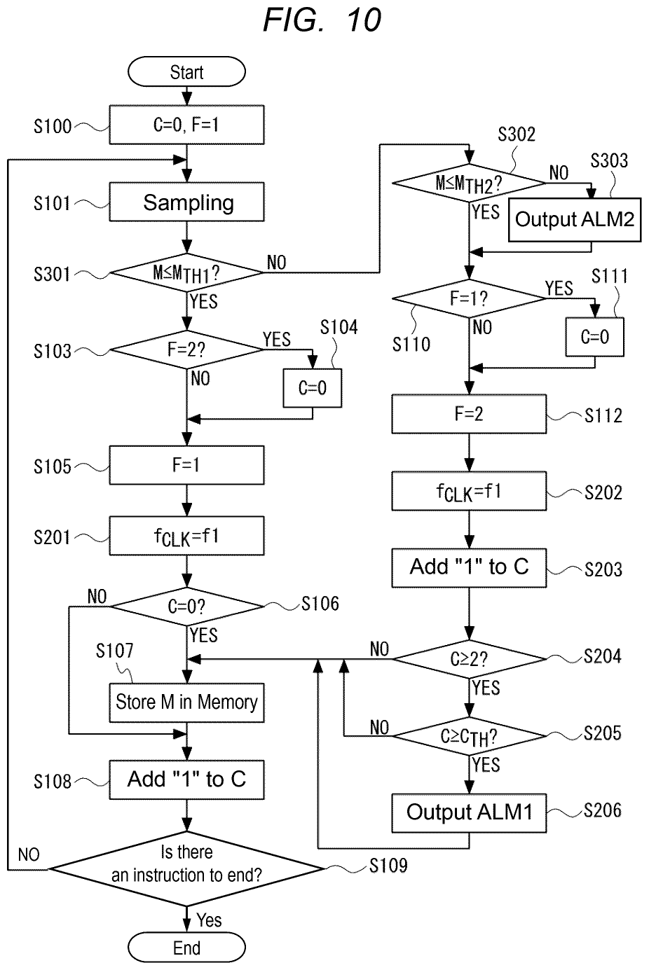

Next, the operation of the semiconductor device 300 will be described. FIG. 10 is a flowchart showing the operation of the semiconductor device according to the third embodiment. In FIG. 10, compared to FIG. 7, step S102 is replaced by steps S301 and S302, and step S303 is added.

### Steps S100 and S101

Steps S100 and S101 in FIG. 10 are the same as steps S100 and S101 in FIG. 4, so the overlapping description is omitted.

### Step S301

The determination unit 2 determines whether the measurement value M is a normal value. Here, as an example, determination unit 2 determines whether the measurement value M is less than or equal to the threshold MTH1. If the measurement value M is less than or equal to the threshold MTH1, the determination unit 2 proceeds to step S103. The threshold MTH1 is also referred to as the first threshold. The range less than or equal to the threshold MTH1 is also referred to as the first range. The range greater than the threshold MTH1 is also referred to as the second range.

### Step S302

If it is determined in step S301 that the measurement value M is greater than the threshold MTH1, the determination unit 2 determines whether the measurement value M is less than or equal to the threshold MTH2. If the measurement value M is less than or equal to the threshold MTH2, the determination unit 2 proceeds to step S110.

### Step S303

If the measurement value M is greater than the threshold MTH2, the determination unit 2 outputs the alarm notification N2 to the alarm output unit 4. The alarm output unit 4 outputs the alarm ALM2 indicating that the measurement value M is greater than the threshold MTH2 to, for example, the management system 120 in response to the alarm notification N2. Then, the determination unit 2 proceeds to step S110. The threshold MTH2 is also referred to as the second threshold. The range greater than the threshold MTH1 and less than or equal to the threshold MTH2 is also referred to as the third range. The range greater than the threshold MTH2 is also referred to as the fourth range. Therefore, the second range, which indicates that the measurement value M is an abnormal value and is greater than the threshold MTH1, is divided into the third range close to the first range and the fourth range far from the first range. The alarm notification N2 is also referred to as the second notification. The alarm ALM2 is also referred to as the second alarm.

### Steps S103 to S112 and S201 to S206

Steps S103 to S112 and S201 to S206 in FIG. 10 are the same as steps S103 to S112 and S201 to S206 in FIG. 7, so the overlapping description is omitted.

In the process of FIG. 10, when the alarm output unit 4 receives alarm notifications N1 and N2, the alarm output unit 4 may output both alarms ALM1 and ALM2. Alternatively, the alarm output unit 4 may output alarm ALM2 as a more urgent alarm and stop the output of alarm ALM1.

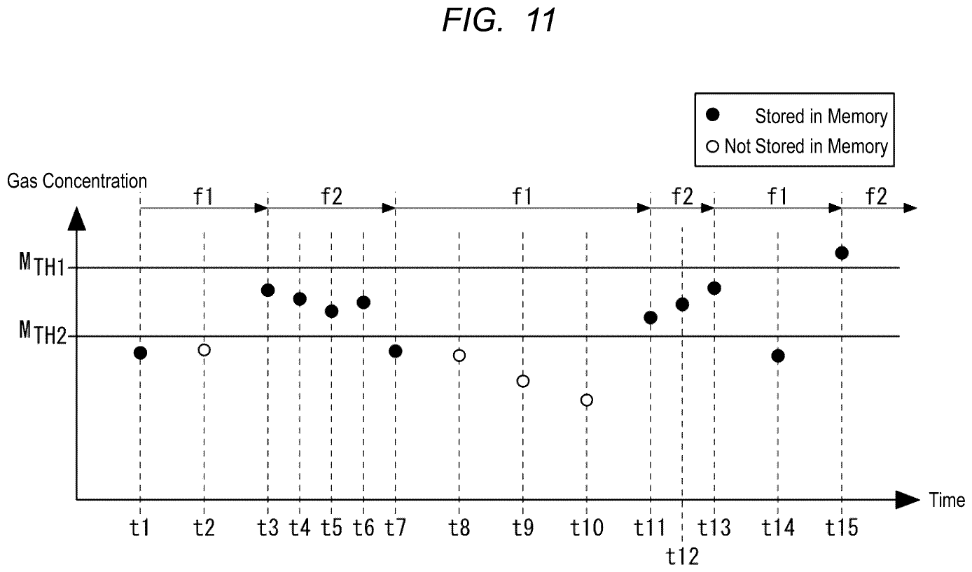

Next, the storage of measurement values in memory in the semiconductor device 300 will be described using an example. FIG. 11 is a diagram showing an example of storing measurement values in memory in the semiconductor device according to the third embodiment. In FIGS. 11, 15 measurement values sampled at consecutive timings t1 to t15 are shown. Black circles indicate measurement values stored in memory 3. White circles indicate measurement values discarded without being stored in memory 3.

In this example, the measurement value at the first timing t1 is less than or equal to the threshold MTH1, so it is a normal value. Therefore, the measurement value at timing t1 is stored in memory 3.

The measurement value at timing t2 is a normal value. Also, the measurement value at the previous timing t1 is a normal value. Therefore, the measurement value at timing t2 is discarded without being stored in memory 3.

The measurement values at timings t3 to t6 are abnormal values belonging to the third reference range, which is greater than or equal to the threshold MTH1 and less than or equal to the threshold MTH2. Therefore, the measurement values at timings t3 to t6 are stored in memory 3. Also, since three or more measurement values consecutively exceed the threshold MTH1, the alarm output unit 4 outputs alarm ALM1 at timing t6.

The measurement value at timing t7 is normal value. On the other hand, the measurement value at the previous timing t6 is an abnormal value. Therefore, the measurement value at timing t7 is stored in memory 3.

The measurement values at timings t8 to t10 are normal values. Also, the measurement values at the previous timings are normal values. Therefore, the measurement values at timings t8 to t10 are discarded without being stored in memory 3.

The measurements from timing t11 to t13 are abnormal values belonging to the third reference range, which is above threshold MTH1 and below threshold MTH2. Therefore, the measurements from timing t11 to t13 are stored in memory 3.

The measurement at timing t14 is a normal value. On the other hand, the measurement at the previous timing t12 is an abnormal value. Therefore, the measurement at timing t14 is stored in memory 3.

The measurement at timing t15 is an abnormal value belonging to the fourth reference range, which is greater than threshold MTH2. Therefore, the measurement at timing t15 is stored in memory 3. Additionally, since the measurement is greater than threshold MTH2, the alarm output section 4 outputs alarm ALM2.

Thus, according to semiconductor device 200, only 11 selected measurements out of 15 can be stored in memory 3. This reduces the number of values stored in memory 3 compared to storing all measured values.

As described above, semiconductor device 300, like semiconductor device 200, can efficiently store desired measurements in memory 3. As a result, even if the capacity of memory 3 is limited, measurements can be accumulated over a long period.

Furthermore, semiconductor device 300, like semiconductor device 200, can more precisely monitor undesirable conditions where measurements become abnormal values. Semiconductor device 300 can output an alarm when a predetermined number of measurements M consecutively become abnormal values, similar to semiconductor device 200.

Additionally, semiconductor device 300 can immediately output an alarm when the measurement M is greater than a predetermined reference value. This allows for the output of an alarm when, for example, the concentration of toxic gas indicated by the measurement is greater than the reference value, prompting restrictions on human entry or evacuation.

### Other Embodiments

The disclosure has been described with reference to the embodiments, but it is not limited to the above embodiments. Various changes can be made to the configuration and details of the disclosure within the scope of the disclosure as understood by those skilled in the art. Each embodiment can be combined with other embodiments as appropriate.

In embodiments 1 and 2, examples of comparing measurements with reference ranges defined by lower and upper limits were described, but these are merely illustrative. In embodiments 1 and 2, measurements may also be compared with thresholds, like embodiment 3.

In embodiment 3, examples of comparing measurements with thresholds were described, but these are merely illustrative. In embodiment 3, measurements may also be compared with the first range defined by lower and upper limits, like embodiments 1 and 2. In this case, a second range that includes the first range may be provided. Then, in step S301 of FIG. 10, it may be determined whether measurement M falls within the first range. Additionally, in step S302 of FIG. 10, it may be determined whether measurement M falls within the second range.

In the above embodiments, examples of storing the first measurement of multiple consecutive normal measurements in memory 3 were described, but these are merely illustrative. If necessary, the first measurement of multiple consecutive normal measurements may not be stored in memory 3. In this case, the number of measurements stored in memory 3 can be further reduced. However, if all measurements indicating normal values are not stored in memory 3, it may be difficult to determine whether the measurement is being conducted normally. Therefore, if prioritizing the determination of whether the measurement is being conducted normally, it is desirable to store the first measurement in memory 3 when multiple consecutive measurements are normal values.

In the above embodiments, it was determined that measurements are normal values when they are above the lower limit and below the upper limit, but this is merely illustrative. Measurements may be determined to be normal values when they are greater than the lower limit and less than the upper limit. Measurements may be determined to be normal values when they are above the lower limit and less than the upper limit. Measurements may be determined to be normal values when they are greater than the lower limit and below the upper limit.

In the above embodiments, it was determined that measurements are normal values when they are below the threshold, but this is merely illustrative. Measurements may be determined to be normal values when they are less than the threshold.

In the above embodiments, the semiconductor device according to the disclosure was mainly described as a hardware configuration, but it is not limited to this. The semiconductor device according to the disclosure can be realized by executing computer programs on a computer. These processes may be realized by executing programs on a computer that include at least one processor (e.g., microprocessor, CPU, GPU, MPU, DSP (Digital Signal Processor)). Specifically, one or more programs containing instructions for performing transmission signal processing or reception signal processing algorithms on a computer may be created and supplied to the computer.

Computer programs can be stored and supplied to a computer using various types of non-transitory computer-readable media. Non-transitory computer-readable media include various types of tangible storage media. Examples of non-transitory computer-readable media include magnetic recording media (e.g., flexible disks, magnetic tapes, hard disk drives), magneto-optical recording media (e.g., magneto-optical disks), CD-ROM (Read Only Memory), CD-R, CD-R/W, semiconductor memory (e.g., masked ROM, PROM (Programmable ROM), EPROM (Erasable PROM), flash ROM, RAM (random access memory)). Programs may also be supplied to a computer by various types of transitory computer-readable media. Examples of transitory computer-readable media include electrical signals, optical signals, and electromagnetic waves. Transitory computer-readable media can supply programs to a computer via wired or wireless communication paths, such as electrical wires and optical fibers.

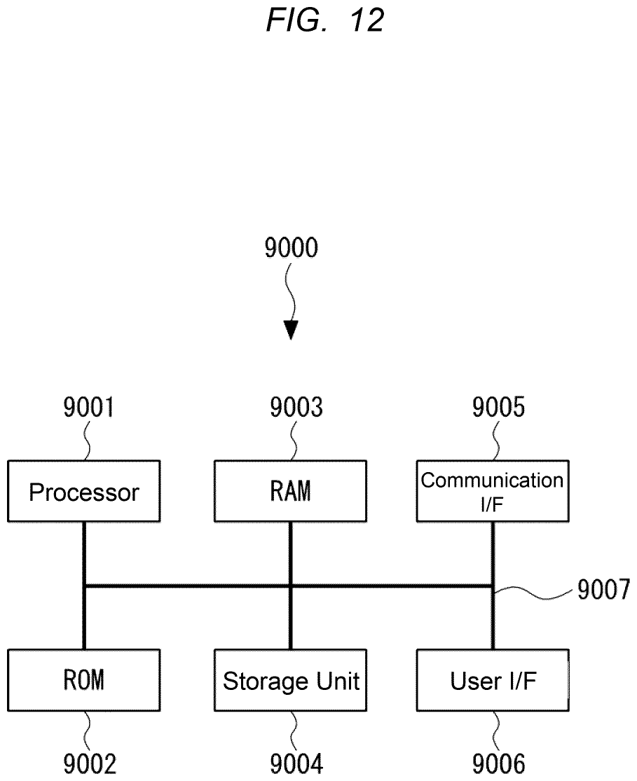

Below is an example configuration of a computer for realizing the semiconductor device according to the above embodiments. FIG. 12 is a diagram showing an example configuration of a computer for realizing the semiconductor device. The semiconductor device can be realized by a computer 9000, such as a dedicated computer or a personal computer (PC). However, the computer does not need to be physically single, and it may be multiple when performing distributed processing. As shown in FIG. 12, computer 9000 includes, for example, processor 9001, ROM (Read Only Memory) 9002, RAM (Random Access Memory) 9003, storage unit 9004, communication interface 9005, and user interface 9006.

Processor 9001, ROM 9002, RAM 9003, storage unit 9004, communication interface 9005, and user interface 9006 are communicatively connected to each other via bus 9007. The description of OS software for operating the computer is omitted, but it is appropriately introduced in computer 9000.

ROM is configured by, for example, nonvolatile semiconductor memory devices. Various programs and other information used in computer 9000 are stored in ROM 9002.

Storage unit 9004 is configured by various storage devices, such as hard disks or solid-state disks. Storage unit 9004 is not limited to storage devices mounted on computer 9000 and may be external storage devices. External storage devices may be clouding storage connected to computers 9000 via various communication means, such as a network. Various programs and data used in computer 9000 are stored in storage unit 9004.

RAM 9003 is configured by volatile semiconductor memory devices. Programs and data used by processor 9001 are appropriately loaded from one or both of ROM 9002 and storage unit 9004 into RAM 9003.

Processor 9001 may be configured by, for example, a CPU (Central Processing Unit). Additionally, processor 9001 may be equipped with a GPU (Graphics Processing Unit) in addition to a CPU. A GPU is suitable for performing routine processing in parallel and can improve processing speed compared to a CPU when used for processing in neural networks, for example. Processor 9001 executes various processes based on various programs stored in ROM 9002 or various programs and data held in RAM 9003. Processor 9001 may also store the data generated by processing in RAM 9003 or the storage unit 9004 as appropriate.

The communication interface 9005 is an interface that connects the computer 9000 to communication networks such as the Internet or intranet through various wired or wireless communication means. This allows the computer 9000 to communicate with other devices, systems, and sensors connected to the communication network.

The user interface 9006 includes a display section that provides information in a manner that the user can recognize, such as through a display device, and a voice output section for audio output. Additionally, the user interface 9006 includes input sections such as a keyboard, mouse, and touch panel, which allow the user to input information into the computer 9000 through operation. The user interface 9006 may also include equipment such as sensors that acquire information useful to the user.

Here, the computer 9000 is described as a single device, but this is merely an example. The computer 9000 may be composed of multiple physically separated devices. Some of these devices may be portable, while others may be stationary.

Each drawing is merely illustrative for explaining one or more embodiments. Each drawing may be associated not only with one specific embodiment but also with one or more other embodiments. As understood by those skilled in the art, various features or steps described with reference to anyone drawing can be combined with features or steps shown in one or more other drawings to create embodiments that are not explicitly illustrated or described. Not all features or steps shown in anyone's drawing are necessarily essential, and some features or steps may be omitted. The order of steps described in any drawing may be changed as appropriate.

What is claimed is:

1. A semiconductor device comprising:
a memory;
a data acquisition unit that acquires data signals input from the outside at a predetermined cycle; and
a determination unit in which a threshold is stored,
wherein the determination unit performs a threshold determination by comparing the data value indicated by the data signal acquired by the data acquisition unit with the threshold, and if it is determined in the threshold determination that the data value is an abnormal value that does not meet a predetermined determination criterion, the data value is stored in the memory.

2. The semiconductor device according to claim 1,
wherein if the first data value indicated by the data signal acquired by the data acquisition unit at a first timing is an abnormal value that does not meet the predetermined determination criterion, and the second data value indicated by the data signal acquired by the data acquisition unit at a second timing following the first timing is a normal value that meets the predetermined determination criterion, the determination unit stores the second data value in the memory.

3. The semiconductor device according to claim 1,
wherein the determination unit sets a first cycle as the predetermined cycle for the data acquisition unit if the data value is a normal value that meets the predetermined determination criterion, and
wherein the determination unit sets a second cycle shorter than the first cycle as the predetermined cycle for the data acquisition unit if the data value is an abnormal value that does not meet the predetermined determination criterion.

4. The semiconductor device according to claim 1,
wherein the determination unit determines whether the data value belongs to either a first range or a second range, which are divided by a first threshold,
wherein if the data value belongs to the first range, the determination unit determines that the data value is a normal value that meets the predetermined determination criterion, and
wherein if the data value belongs to the second range, the determination unit determines that the data value is an abnormal value that does not meet the predetermined determination criterion.

5. The semiconductor device according to claim 4,
wherein the determination unit determines whether the data value belongs to either the first range or the second range based on which of the first and second ranges the first threshold belongs to.

6. The semiconductor device according to claim 5, further comprising:
an alarm output unit that issues an alarm based on a first notification,
wherein if a predetermined number of consecutively acquired data values belong to the second range, the determination unit outputs the first notification to the alarm output unit, and
wherein the alarm output unit outputs a first alarm in response to the first notification.

7. The semiconductor device according to claim 6,
wherein the second range is divided by a second threshold into a third range adjacent to the first range and a fourth range adjacent to the third range,
wherein the determination unit determines whether the data value belongs to either the third range or the fourth range,
wherein if the data value belongs to the fourth range, the determination unit outputs a second notification to the alarm output unit, and
wherein the alarm output unit outputs a second alarm in response to the second notification.

8. The semiconductor device according to claim 7,
wherein the determination unit determines whether the data value belongs to either the third range or the fourth range based on which of the third and fourth ranges the second threshold belongs to.

9. The semiconductor device according to claim 1,
wherein the determination unit determines that the data value is a normal value that meets the determination criterion if the data value falls within a first range defined by a lower limit and an upper limit.

10. The semiconductor device according to claim 9, further comprising:
an alarm output unit that issues an alarm based on a first notification,
wherein if a predetermined number of consecutively acquired data values do not fall within the first range, the determination unit outputs the first notification to the alarm output unit, and
wherein the alarm output unit outputs a first alarm in response to the first notification.

11. The semiconductor device according to claim 10,
wherein if the data value does not fall within a second range set to include the first range, the determination unit outputs a second notification to the alarm output unit, and
wherein the alarm output unit outputs a second alarm in response to the second notification.

12. A method for controlling a semiconductor device, comprising:
a step of acquiring data signals input from the outside at a predetermined cycle,
a step of performing a threshold determination by comparing the data value indicated by the acquired data signal with a threshold, and
a step of storing the data value in a memory provided in the semiconductor device if it is determined in the threshold determination that the data value is an abnormal value that does not meet a predetermined determination criterion.

13. A program to run on a computer, comprising:
a process of acquiring data signals input from the outside at a predetermined cycle,
a process of performing a threshold determination by comparing the data value indicated by the acquired data signal with a threshold, and
a process of storing the data value in a memory provided in the semiconductor device if it is determined in the threshold determination that the data value is an abnormal value that does not meet a predetermined determination criterion.
